(19) United States
(12) Patent Application Publication
(10) Pub. No.: US 2008/0017440 A1
(43) Pub. Date: Jan. 24, 2008

(54) Noise reduction apparatus

(75) Inventors: Naohito Seko, Kariya-city (JP); Kazuhiro Hayashi, Nishikamo-gun (JP); Naoya Katoh, Ama-gun (JP); Makoto Otsubo, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/806,137

(22) Filed: May 30, 2007

(30) Foreign Application Priority Data
Jul. 21, 2006 (JP) 2006-199178

(51) Int. Cl. G10K 11/16

(52) U.S. Cl. 181/175

(57) ABSTRACT

A noise reduction apparatus includes an intake passage forming member defining an intake passage, a resonator, and a vibration film. Intake air drawn into a combustion chamber of an internal combustion engine flows through the intake passage. The resonator has an inner volume part branching from the intake passage. The vibration film is placed to separate the intake passage from the inner volume part. The vibration film is vibrated by a sound pressure of a sound that is generated in the combustion chamber and that propagates through the intake passage. The vibration film has a projection part, which separates the vibration film into an inner vibration film part and an outer vibration film part.

### CROSS REFERENCE TO RELATED APPLICATION

This application is based on and incorporates herein by reference Japanese Patent Application No. 2006-199178 filed on Jul. 21, 2006.

### BACKGROUND OF THE INVENTION

1. Field of the Invention

The present invention relates to a noise reduction apparatus.

2. Description of Related Art

It is known that, for example, a resonator is provided to a passage member, out of which an intake passage is formed, in order to control noise of an engine of an automobile. A noise reduction apparatus in JP2004-293365A has a vibration film that divides an inner volume part inside the resonator from the intake passage. The vibration film vibrates by sound pressures of sounds, which are generated in a combustion chamber and propagate through the intake passage. Vibration of the sounds that propagate through the intake passage resonates with the vibration of the vibration film and is thereby canceled out. As a result, the noise of the engine is reduced.

In the noise reduction apparatus in JP2004-293365A, by pressing a pressing bar, which is driven by an actuator, on the vibration film, tension of the vibration film is made variable. Consequently, a sound of a particular frequency, out of the sounds generated in the combustion chamber and propagate through the intake passage, is not limited to being canceled out, but sounds of various frequencies can be canceled out.

However, in the noise reduction apparatus in JP2004-293365A, although sounds of various frequencies can be canceled out, a natural frequency of the vibration film is changed by controlling the tension of the vibration film. Accordingly, control accuracy, with which the vibration film is controlled to have a desired natural frequency, is low. Furthermore, since the actuator is required in order to control the tension, power consumption increases and the apparatus is upsized.

### SUMMARY OF THE INVENTION

The present invention addresses the above disadvantages. Thus, it is an objective of the present invention to provide a noise reduction apparatus, which can cancel out sounds of various frequencies with high control accuracy maintained, and does not require an actuator thereby to avoid increase in power consumption and upsizing of the noise reduction apparatus.

To achieve the objective of the present invention, there is provided a noise reduction apparatus including an intake passage forming member, a resonator, and a vibration film. The intake passage forming member defines an intake passage. Intake air, which is drawn into a combustion chamber of an internal combustion engine, flows through the intake passage. The resonator has an inner volume part, which branches from the intake passage, inside the resonator. The vibration film is placed to separate the intake passage from the inner volume part. The vibration film is vibrated by a sound pressure of a sound that is generated in the combustion chamber and that propagates through the intake passage. The vibration film has a projection part that projects in a direction in which the vibration film is vibrated and that extends generally annularly. The projection part separates the vibration film into an inner vibration film part, which is radially inward of the projection part, and an outer vibration film part, which is radially outward of the projection part.

### BRIEF DESCRIPTION OF THE DRAWINGS

The invention, together with additional objectives, features and advantages thereof, will be best understood from the following description, the appended claims and the accompanying drawings in which:

FIG. 1 is a schematic cross-sectional view showing a noise reduction apparatus according to a first embodiment of the present invention;

FIG. 2 is a perspective view of a vibration film in FIG. 1;

FIG. 3A is a front view of the vibration film in FIG. 2;

FIG. 3B is a cross-sectional view of the vibration film along a line IIIB-IIIB in FIG. 3A;

FIG. 4 is a graph showing a relationship between a frequency and a noise-canceling level of a sound that is generated in a combustion chamber and propagates through an intake passage, thereby showing an effect of the noise reduction apparatus according to the first embodiment;

FIG. 5A is a graph showing amplitudes of an inner vibration film part and an outer vibration film part of the noise reduction apparatus according to the first embodiment, for a sound of low frequency;

FIG. 5B is a graph showing amplitudes of the inner vibration film part and the outer vibration film part of the noise reduction apparatus according to the first embodiment, for a sound of high frequency;

FIG. 6A is a front view of a vibration film according to a second embodiment of the present invention; and

FIG. 6B is a cross-sectional view of the vibration film along a line VIB-VIB in FIG. 6A.

### DETAILED DESCRIPTION OF THE INVENTION

Embodiments of the present invention are described below with reference to drawings.

### First Embodiment

A noise reduction apparatus according to a first embodiment is installed in a vehicle having an internal combustion engine. In noise reduction apparatus, a sound pressure of a sound, which propagates through an intake passage, out of sounds generated in a combustion chamber of the internal combustion engine, is reduced. As a result, an engine noise generated toward vehicle occupants and the like is reduced. A configuration of the noise reduction apparatus is described in detail below.

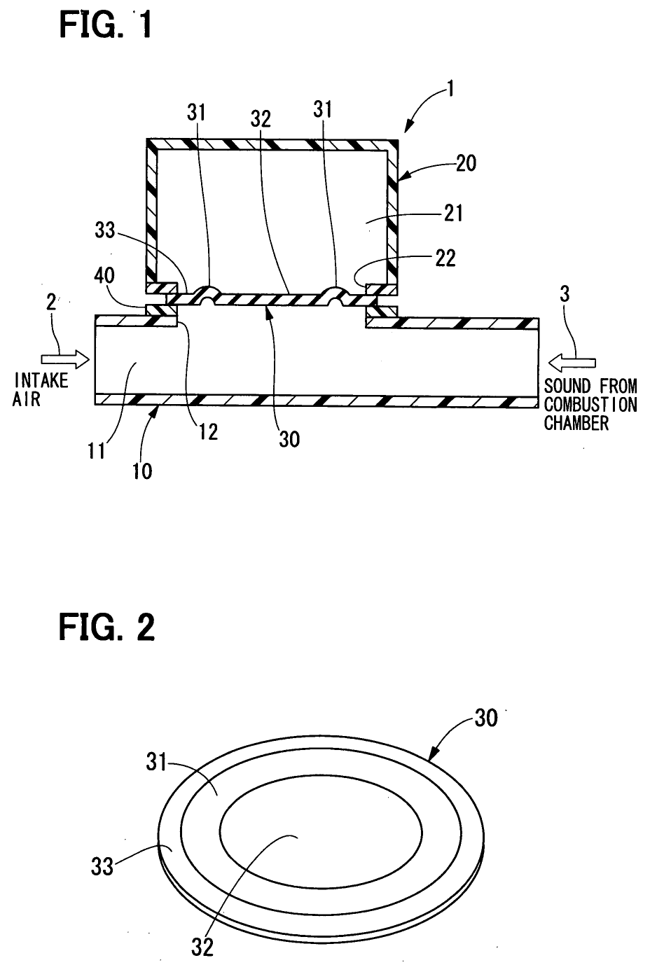

FIG. 1 is a schematic cross-sectional view showing a noise reduction apparatus 1 according to the first embodiment of the present invention. As shown in FIG. 1, the noise reduction apparatus 1 has an air intake duct 10 as a passage member, a resonator 20, and a vibration film 30. The air intake duct 10 and the resonator 20 are made of resin, and the vibration film 30 is made of an elastically deformable material (e.g., rubber and elastomer rubber). In the first embodiment, silicon rubber (e.g., fluorosilicone rubber), which has excellent swelling resistance to fuel, is employed as the material the vibration film 30.

The air intake duct 10 is a part of an intake route that leads intake air to a combustion chamber (not shown) of the internal combustion engine. More specifically, the air intake duct 10 is a duct that connects a surge tank (not shown) and a throttle apparatus (not shown). In an intake passage 11 formed in the air intake duct 10, intake air (indicated by an arrow 2 in FIG. 1) flows into the combustion chamber of the internal combustion engine.

The air intake duct 10 has an opening 12, to which the resonator 20 is attached via the vibration film 30. An inner volume part 21 is formed inside the resonator 20. A part of the resonator 20, which is opposed to the opening 12 of the air intake duct 10, is an opening 22. The openings 12, 22 are sealed with the vibration film 30. Accordingly, the inner volume part 21 is a space sealed with the resonator 20 and the vibration film 30.

The vibration film 30 has a circular disklike shape. The openings 12, 22 have circular shapes, which are concentric with the vibration film 30. An arrow 3 in FIG. 1 indicates a sound that is generated in the combustion chamber and propagates through the intake passage 11. The vibration film 30 is vibrated by a sound pressure of the sound in a direction of its central axis (i.e., vertical direction in FIG. 1). Since the inner volume part 21 is the sealed space as described above, the above vibration of the vibration film 30 is vibration of a spring-mass system with air in the inner volume part 21 serving as an air spring.

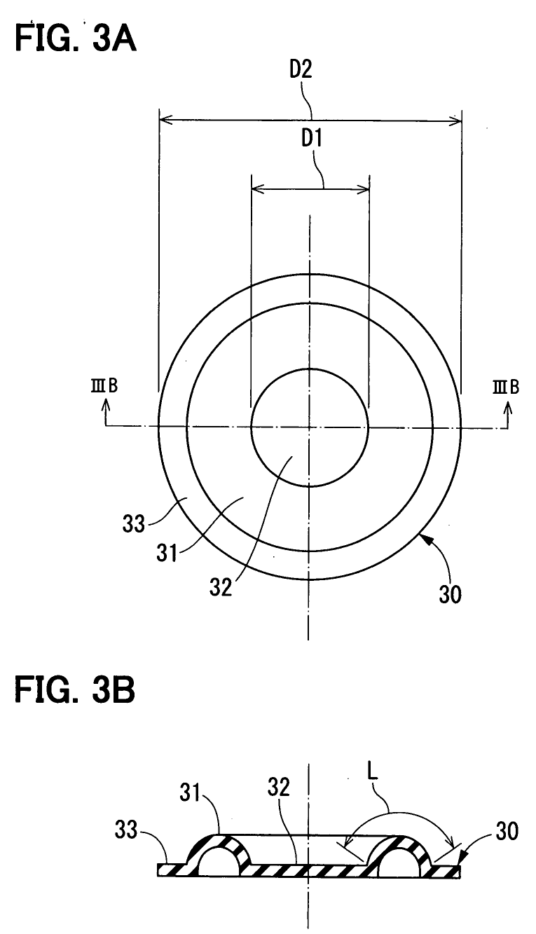

FIG. 2 is a perspective view of the vibration film 30. FIG. 3A is a front view of the vibration film 30. FIG. 3B is a cross-sectional view of the vibration film 30 along a line IIIB-IIIB in FIG. 3A. As shown in FIGS. 2, 3A, 3B, the vibration film 30 has a shape like a diaphragm having an annular projection part 31, which projects in a direction of the vibration and extends annularly. The annular projection part 31 divides the vibration film 30 into an inner vibration film part 32, which is located on an inner side of the annular projection part 31, and an outer vibration film part 33, which is located on an outer side of the annular projection part 31.

Additionally, an outer circumferential part of the outer vibration film part 33 of the vibration film 30 is held between the resonator 20 and a ring member 40 (FIG. 1) made of resin.

As shown in FIG. 3B, the inner vibration film part 32 and the outer vibration film part 33 have shapes like a flat plate that extends in the same plane. The annular projection part 31 is a curvature projecting in the direction of the vibration from the plane, and has an arc-shaped cross-sectional surface. The annular projection part 31, the inner vibration film part 32, and the outer vibration film part 33 have the same material thickness. In addition, an inside diameter size D1 of the annular projection part 31 may preferably be in a range of 50 [mm] to 100 [mm], and an outside diameter size D2 of the vibration film 30 may preferably be in a range of 50 [mm] to 130 [mm]. A material thickness size of the vibration film 30 may preferably be in a range of 0.1 [mm] to 3 [mm]. More specifically, a thickness of the annular projection part 31 may preferably be equal to or smaller than a thickness of the inner vibration film part 32.

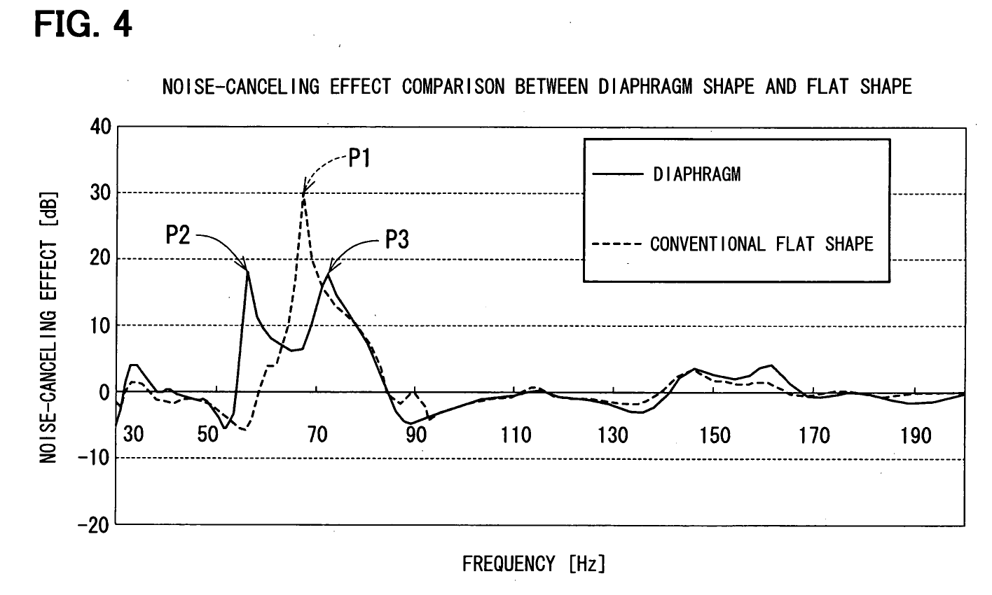

According to the first embodiment, the vibration film 30 has the annular projection part 31, which divides the inner vibration film part 32 from the outer vibration film part 33, and has a shape like a diaphragm. Accordingly, the vibration of the vibration film 30 can resonate with vibration of a frequency (approximately 55 [Hz]) indicated by P2 in FIG. 4 and also with vibration of a frequency (approximately 75 [Hz]) indicated by P3, out of the vibrations of sounds that are generated in the combustion chamber and propagate through the intake passage 11. In addition, FIG. 4 is a graph showing results of a test, in which a noise-canceling level (dB) is calculated at frequencies in a range of 30 [Hz] to 200 [Hz]. To conduct the test, a loudspeaker is placed on one end side the passage member, and a microphone is placed on the other end side. Sounds of various frequencies in a range of 30 [Hz] to 200 [Hz] are outputted from the loudspeaker in turn, and a sound pressure of a sound of each of the frequencies is detected by the microphone. By comparing a sound pressure of the sound of each of the frequencies outputted from the loudspeaker and the sound pressure detected by the microphone, a reduced sound pressure is calculated as the noise-canceling level (dB) at each of the frequencies. A vertical axis of the graph of FIG. 4 indicates the noise-canceling level (dB), and a horizontal axis indicates the frequency (Hz). A continuous line in the graph indicates results of the test, in which the vibration film 30 according to the first embodiment is used, and a dashed line indicates results of the test, in which a conventional vibration film without having the projection part 31 is used. According to the results of the test, the noise-canceling level has its peak (P1 in FIG. 4) only at a particular frequency when the conventional vibration film is used, and the noise-canceling level has its peaks (P2, P3 in FIG. 4) at a plurality of frequencies when the vibration film 30 according to the first embodiment is used.

Thus, when a sound that is generated in the combustion chamber and propagates through the intake passage 11 has a frequency around 55 [Hz], vibration of the frequency around 55 [Hz] resonates with the vibration of the vibration film 30, and thereby the sound having the vibration of the frequency around 55 [Hz] is canceled out. When a sound that is generated in the combustion chamber and propagates through the intake passage 11 has a frequency around 75 [Hz], vibration of the frequency around 75 [Hz] resonates with the vibration of the vibration film 30, and thereby the sound having the vibration of the frequency around 75 [Hz] is canceled out. That is, the sounds of two frequencies (i.e., 55 [Hz], 75 [Hz]) can be canceled out.

In this manner, according to the first embodiment, a conventional actuator for varying tension is unnecessary, and the sounds of the two frequencies can be canceled out. As well, high control accuracy is maintained, and increase in power consumption due to the actuator and upsizing of the noise reduction apparatus can be avoided.

Furthermore, according to the first embodiment, since the annular projection part 31 and the inner vibration film part 32 have the same material thickness, amplitude of the inner vibration film part 32 can be made large as compared to a case in which the material thickness of the annular projection part 31 is larger than that of the inner vibration film part 32, and thereby a noise-canceling level can be made high.

Besides, according to the first embodiment, since the annular projection part 31 has the arc-shaped cross-sectional surface, the amplitude of the inner vibration film part 32 can be made large, and consequently, the noise-canceling level can be made high.

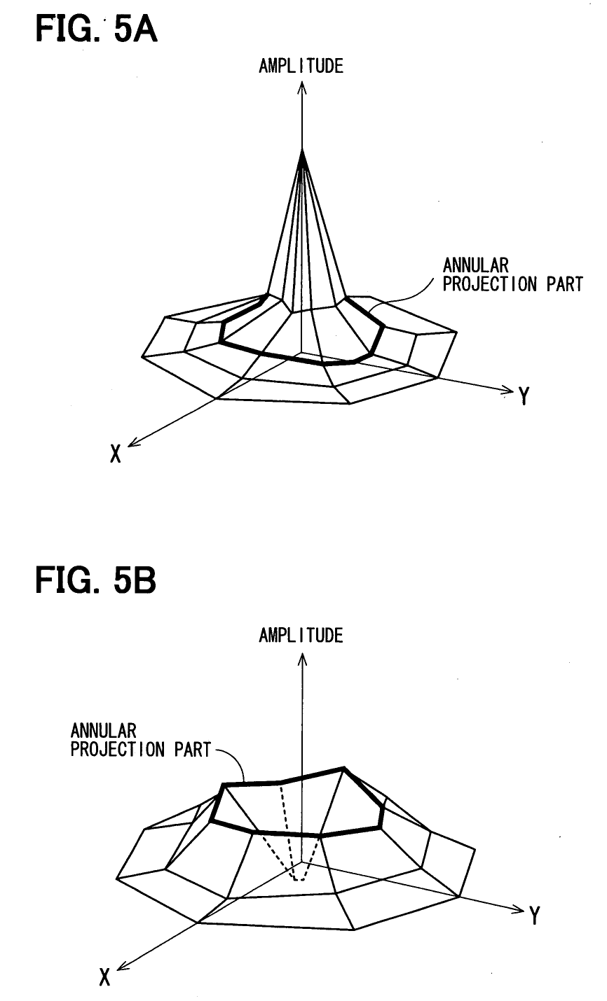

In addition, it is verified by a test that, when the annular projection part 31 is formed on the vibration film 30, the vibration film 30 vibrates in a manner shown in FIGS. 5A, 5B. An X-axis and a Y-axis in FIGS. 5A, 5B indicate coordinate axes of X, Y coordinates indicating positions in a plane of the vibration film 30. A Z-axis indicates magnitude of amplitude. Bold lines in FIGS. 5A, 5B indicate positions of the annular projection part 31 in the X, Y coordinates.

Results of the test are described below. In regard to behavior of the vibration film 30 towards a sound of low frequency, which is lower than a predetermined value, the inner vibration film part 32 of the vibration film 30 mainly vibrates, and the annular projection part 31 and the outer vibration film part 33 do not vibrate very much (FIG. 5A). In regard to behavior of the vibration film 30 towards a sound of high frequency, which is higher than the predetermined value, on the other hand, the whole part of the vibration film 30 vibrates (FIG. 5B). More specifically, the inner vibration film part 32 of the vibration film 30 and the outer vibration film part 33 vibrate at the same frequency and in opposite phase to each other.

### Second Embodiment

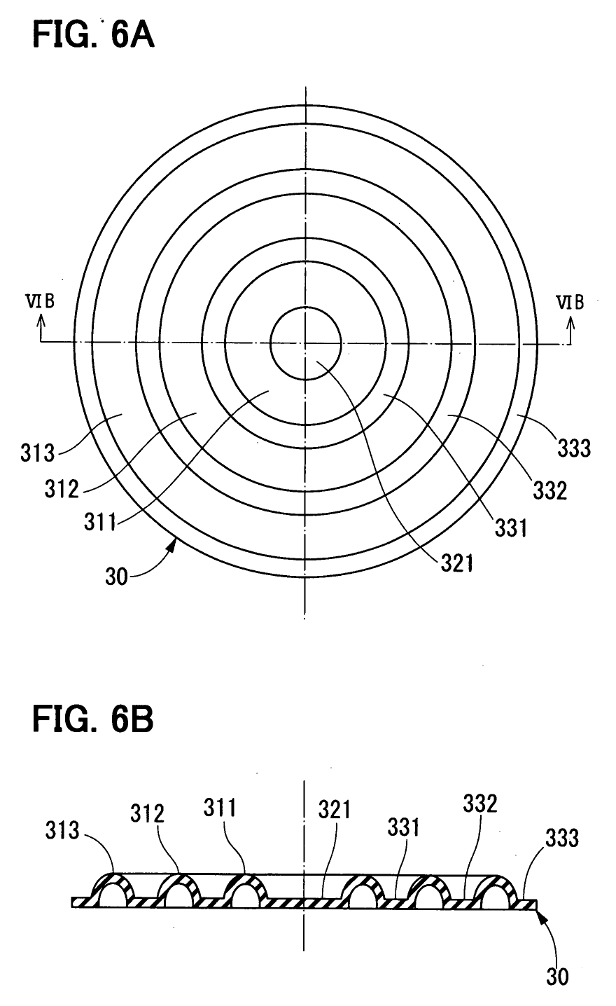

A second embodiment of the present invention is shown in FIGS. 6A, 6B. In the following description and drawings, the same numerals are used to indicate substantially the same parts as the first embodiment.

In the first embodiment, the vibration film 30 has one annular projection part 31, while on the other hand, the vibration film 30 according to the second embodiment has a plurality of annular projection parts 311, 312, 313. The annular projection parts 311, 312, 313 are arranged concentrically with each other. Accordingly, the vibration film 30 has one inner vibration film part 321 and three outer vibration film parts 331, 332, 333.

By using the above configuration, the number of frequencies of vibration, with which the vibration film 30 can resonate, is increased to three and above, so that sounds of three frequencies and above can be canceled out.

### Other Embodiments

In the first embodiment, one annular projection part 31 extends annularly. Alternatively, a plurality of projection parts extending in an arc-shaped manner may be arranged annularly.

Additionally, to make large the amplitude of the inner vibration film part 32, circumferential length L (FIG. 3B) of the annular projection part 31 may be set at a large value. That is, by adjusting the circumferential length L, the amplitude of the inner vibration film part 32 can be readily adjusted.

In each embodiment above, the annular projection part 31 has the arc-shaped cross-sectional surface. However, the annular projection part 31 is not limited to having such shapes. The annular projection part 31 may have a triangular cross-sectional surface or a quadrangular cross-sectional surface, for example.

In the first embodiment, the noise reduction apparatus 1 is provided at the duct that connects the surge tank and the throttle apparatus. However, an installation location of the noise reduction apparatus 1 is not limited to the above duct. For example, the noise reduction apparatus 1 may be provided at the surge tank. As well, the noise reduction apparatus 1 may be provided at an inlet case forming an air inlet, an air cleaner case that receives an air cleaner, a fresh air duct that connects the inlet case and the air cleaner case, or the like.

In this manner, the present invention is not by any means limited to the above embodiments, and it can be applied to various embodiments without departing from the scope of the invention.

Additional advantages and modifications will readily occur to those skilled in the art. The invention in its broader terms is therefore not limited to the specific details, representative apparatus, and illustrative examples shown and described.

What is claimed is:

1. A noise reduction apparatus comprising:
an intake passage forming member, which defines an intake passage, wherein intake air, which is drawn into a combustion chamber of an internal combustion engine, flows through the intake passage;
a resonator having an inner volume part, which branches from the intake passage, inside the resonator; and
a vibration film that is placed to separate the intake passage from the inner volume part, wherein:
the vibration film is vibrated by a sound pressure of a sound that is generated in the combustion chamber and that propagates through the intake passage; and
the vibration film has a projection part that projects in a direction in which the vibration film is vibrated and that extends generally annularly, wherein the projection part separates the vibration film into an inner vibration film part, which is radially inward of the projection part, and an outer vibration film part, which is radially outward of the projection part.

2. The noise reduction apparatus according to claim 1, wherein a thickness of the projection part is equal to or smaller than a thickness of the inner vibration film part.

3. The noise reduction apparatus according to claim 1, wherein the projection part has an arc-shaped cross-sectional surface.

4. The noise reduction apparatus according to claim 1, wherein the projection part is one of a plurality of projection parts, which extend generally annularly and are concentric with each other.
